(19) United States
(12) Patent Application Publication
(10) Pub. No.: US 2013/0119156 A1
(43) Pub. Date: May 16, 2013

(54) PAINT SPRAYER

(71) Applicant: Jamie S. Munn, Sherwood, OR (US)

(72) Inventors: Jamie S. Munn, Sherwood, OR (US); Gareth Richards, Co Durham (GB)

(21) Appl. No.: 13/464,839

(22) Filed: May 4, 2012

Related U.S. Application Data
(60) Provisional application No. 61/559,919, filed on Nov. 15, 2011.
(60) Provisional application No. 61/583,054, filed on Jan. 4, 2012.
(60) Provisional application No. 61/583,450, filed on Jan. 5, 2012.

(51) Int. Cl. B05B 7/26

(52) U.S. Cl. CPC B05B 7/26
USPC 239/310; 137/315.01

(57) ABSTRACT

A (paint) sprayer having a wet part, a dry part and a component (such as a piston) that, when in place when the wet and dry parts are operatively assembled together at least in part prevents leakage from the wet part to the dry part. A device or mechanism (such as a flexible clip or a pivotal bracket) connected to one of the parts prevents the wet and dry parts from being assembled together when the component is not in place relative to the one of the parts.

### CROSS REFERENCE TO RELATED APPLICATIONS

This application claims the benefit of U.S. Provisional Patent Application Ser. No. 61/559,919, filed Nov. 15, 2011; Ser. No. 61/583,054, filed Jan. 4, 2012; and Ser. No. 61/583,450 filed Jan. 5, 2012. The entire contents of each of these applications are hereby incorporated by reference.

### FIELD

The present disclosure relates to sprayers for spraying fluids such as paints and stains, and also relates to sprayers having a wet part that can be disconnected from a dry part.

### BACKGROUND

Paint sprayers are well known in the art, and an example thereof is disclosed in PCT/US2010/057041 ('041 PCT application). The '041 PCT application was filed on Nov. 17, 2010, published on May 26, 2011 as WO 2011/062992, and its entire contents are hereby incorporated by reference.

### SUMMARY

This section provides a general summary of the disclosure and one or more of its advantages, and is not a comprehensive disclosure of the full scope, of all of the features, of all of the alternatives or embodiments or of all of the advantages.

The present inventors have discovered that if a sprayer, such as that disclosed in the '041 PCT application, is disassembled, for example to clean it to prevent leftover paint from drying and plugging up the sprayer, and then reassembled by connecting the wet housing portion (or wet part or front part) to the dry housing portion (or dry part or rear part) but with the piston not in position, extending between the two portions (or parts), the reservoir chamber may leak. The chamber may leak, especially if the sprayer is tilted, through the space left by the missing piston and to the solenoid motor and/or to the switch located in the handle, causing an electrical short. More specifically, the piston when in position seals the wet part off from the dry part. If the wet and dry parts are connected without the piston, paint, light body stains, sealing liquids and/or water can flow from the wet part to the dry part. The inventors herein have discovered that a need exists for a paint sprayer construction that does not suffer from this problem. This problem can also be defined as occurring when the front (wet) and rear (dry) parts of a sprayer are assembled together without a component that provides a sealing function between the two parts.

Pursuant to teachings herein, various alternative mechanisms or devices are provided to prevent the wet part of the sprayer from being connected to the dry part when the piston (or other sealing component of the sprayer) is not in place or to dissuade the user from connecting them together.

Pursuant to a first embodiment, the mechanism can extend out from one of the parts (for example, the rear or dry part) towards the other (for example, the front or wet part) and can have two configurations. In the first configuration when the piston is not in place and assembly of the two parts is attempted, the distal end of the mechanism butts against or impacts the other of the parts and blocks assembly of the two parts. However, when the piston is in place in the one of the parts, the piston biases/flexes/bends the distal end portion of the mechanism such that the mechanism is in the second configuration. When the assembly of the two parts is then attempted, the distal end portion fits into an aligned opening in the other of the parts, allowing the two parts to be assembled together.

The mechanism, according to a second embodiment, is biased when the piston is not in place to a first position wherein the mechanism prevents actuation of an actuator (button), which thereby prevents the front and rear parts from being assembled. With the piston in place, the mechanism is moved to a second position in which it does not prevent actuation of the actuator.

The mechanism, according to a third embodiment, is biased to a normal position when the piston is not in place, blocking the first and second parts from being assembled together. With the piston in place, the mechanism is held by the piston in another position in which assembly of the first and second parts is not thereby blocked. In that position the mechanism can extend towards the opposing part and slide, together with an end of the piston, into an opening in that opposing part to thereby assemble the two parts.

In accordance with a definition of the present disclosure is a sprayer which includes: a sprayer rear part; a sprayer front part positionable in an operative connected position relative to the rear part and in an alternative disconnected position relative to the rear part; and a piston positionable in an operative position extending between the rear part and the front part with the front part in the connected position and alternatively positionable in a disconnected position, disconnected from both the rear and front parts when the front part is in the disconnected position. The sprayer is constructed such that the front part of the sprayer is not positionable in the operative connected position when the piston is in the disconnected position.

In accordance with another definition of the disclosure is a sprayer which includes: a sprayer rear part; a sprayer front part positionable in a connected position relative to the rear part and in an alternative disconnected position relative to the rear part; a piston positionable in an operative position extending between the rear part and the front part with the front part in the connected position and alternatively positionable in a disconnected position disconnected from both the rear and front parts when the front part is in the disconnected position; and means for preventing the front part from being positionable in the connected position when the piston is in the disconnected position. Examples of the preventing means can include a flexible cantilevered clip, a pivotal blocking bracket, and a pivotal stopper that can block actuation of a latch to a position in which the two parts can be connected.

In accordance with a further definition of the disclosure is a sprayer which includes: a sprayer dry part; a sprayer wet part positionable in an operative connected position relative to the dry part and in an alternative disconnected position relative to the dry part; a component that at least in part prevents leakage from the wet part to the dry part when the wet and dry parts are operatively connected together; and means for preventing the wet part from being positioned in the operative connected position when the component is not in place. Examples of the preventing means can include a flexible cantilevered clip, a pivotal blocking bracket, and a pivotal stopper that can block actuation of a latch of the sprayer housing to a position that allows the two parts to be latched together.

In accordance with a still further definition of the disclosure is a sprayer which includes: a sprayer rear part; a sprayer front part positionable in an operative connected position relative to the rear part and in an alternative disconnected position relative to the rear part; a piston positionable in an operative position extending between the rear part and the front part with the front part in the connected position and alternatively positionable in a disconnected position disconnected from both the rear and front parts when the front part is in the disconnected position; and a locking assembly that cannot lock the front part to the rear part unless the piston is in place. The locking mechanism can include a latch actuator that is operative to lock or latch the front part to the rear part only when the piston is in place. Further, the latch actuator can include a button that is operative when in a depressed position. Still further, the locking mechanism can include a pivotal lock or stopper that has a normal position rendering the latch actuator inoperative when the piston is not in place and is biased to a lockable position by the piston when the piston is in place.

In accordance with a yet still further definition of the disclosure is a sprayer which includes: a sprayer first portion that includes a motor; a sprayer second portion that includes a sprayer and/or a reservoir; and a sprayer component whose absence from a position between the first and second portions prevents the first and second portions from being assembled together and whose presence in a position between the first and second portions at least in part prevents leakage from the second portion to the first portion with the portions assembled together. The sprayer can include a mechanism connected to at least one of the portions and configured to detect the presence of the component when the portions are disconnected and if the component is not detected, prevents the portions from being assembled together.

Instead of the mechanism as described in the above paragraph the sprayer can include a mechanism having a first position or configuration when the component is not in place and a second position or configuration when the component is in place. The mechanism when in the first position or configuration prevents the first and second portions from being operatively assembled together. The component when in place causes the mechanism to pivot to or to bend to the second position or configuration, which does not prevent the portions from being assembled.

In accordance with a still further definition of the disclosure is a sprayer which includes: a sprayer first part; a sprayer second part; the sprayer first part being positionable in an operative connected position relative to the second part and in an alternative disconnected position relative to the second part; a component that at least in part prevents leakage from one of the first and second parts to the other when the first and second parts are in the operative connected position; and a mechanism connected to the first and/or second parts and positionable in a first position or configuration and in an alternative second position or configuration. The mechanism, when the component is not in place in the one of the first and second parts and the first part is in the disconnected position, is in the first position or configuration, which prevents the first and second parts from being positioned in the connected position. And the mechanism, when the component is in place in the one of the first and second parts and the first part is in the disconnected position, is in the second position or configuration, which does not prevent the first and second parts from being positioned in the connected position.

The mechanism mentioned in the paragraph above can include an elastic member and a bracket. The elastic member can bias the bracket to the first position or configuration wherein at least a portion of the bracket extends from one of the first and second parts towards the other and in a position that blocks the parts from being in the connected position; and the bracket can be held by the elastic member against the component when the component is in place in the first or second part and thereby in the second position or configuration wherein at least a portion of the bracket can pass into an opening in the other of the first and second parts when the parts are being connected together.

In accordance with a still further definition of the disclosure is a sprayer which includes: a sprayer rear part; a sprayer front part positionable in an operative connected position relative to the rear part and in an alternative disconnected position relative to the rear part; a piston positionable in an operative position extending between the rear part and the front part when the front part is in the connected position and alternatively positionable in a disconnected position disconnected from both the rear part and the front part when the front part is in the disconnected position; and a blocking mechanism connected to the rear and/or front parts and configured to prevent the front part from being positioned in the connected position when the piston is in the disconnected position. The blocking mechanism can include a pivotal blocking bracket, a pivotal stopper or a cantilevered clip.

In accordance with a still further definition of the disclosure is a sprayer which includes: a sprayer wet part; a sprayer dry part; a sprayer component that at least in part prevents leakage from the wet part to the dry part when the wet and dry parts are operatively connected together; and a mechanism connected to the wet and/or dry parts and configured to prevent the wet and dry parts from being operatively connected together without the component being in place relative to at least one of the wet and dry parts. The dry part can include a motor, the wet part can include a pump, the component can include a piston and the mechanism can include an elastic device. The component can be in place when an end portion thereof is operatively in an opening or recess in the at least one of the wet and dry parts.

In accordance with a still further definition of the disclosure is a sprayer which includes: a sprayer rear part; a sprayer front part positionable in an operative connected position connected to the rear part and in an alternative disconnected position relative to the rear part; a piston positionable in an operative position extending between the rear part and the front part with the front part in the connected position and alternatively positionable in a disconnected position disconnected from both the rear and front parts when the front part is in the disconnected position; and an elastic device connected to the rear and/or front parts and positionable in a first position wherein the first and second parts can be assembled together in the connected position and an alternative second position wherein the first and second parts are prevented from being assembled together in the connected position. The elastic device can be moved from the second position to the first position by the insertion of an end portion of the piston into an opening in the rear or front part. The elastic device can be automatically biased from the first position to the second position when the piston is removed from the opening.

In accordance with another teaching herein, a tie or tether can tie or tether the piston to the first or second part of a sprayer. Thereby the user will be unlikely to forget to assemble the piston operatively between the first and second parts when connecting the first and second parts together.

Pursuant to another definition of a disclosure herein a lock-out is provided for a (paint) sprayer having a quick release mechanism. The lock-out prevents a front part of the sprayer from being attached to (or snapped together with) the back end or part of the sprayer unless the sprayer piston is present. The lock-out can include a tab that can be engaged by the piston arranged on the front part of the sprayer which allows a button to be moved and the front part of the sprayer to be locked into the back end or part. In other words, the presence of the piston actuates the “lock-out” which defeats the lock-out and allows the assembly and operation of the sprayer. If the piston is not present, the lock-out will not be tripped and the front part of the sprayer will not be allowed to be attached to the back end or part.

Disclosed herein is a sprayer, and particularly a solenoid-type paint sprayer, that prevents ingress of water (or other liquids) to the electrical housing in the event that the sprayer is incorrectly assembled, such as by omitting one or more components (for example, the piston).

### BRIEF DESCRIPTION OF THE DRAWINGS

The drawings described herein are for illustrative purposes only of selected aspects of the present teachings and not all possible implementations, and are not intended to limit the scope of the present teachings.

FIG. 1 is a side elevational view of a sprayer, such as the sprayer disclosed in the '041 PCT application, which can be adapted to include teachings of the present disclosure.

FIG. 2 is a partially exploded, partially sectional perspective view of the sprayer of FIG. 1.

FIG. 3 is a partially exploded, perspective view of the sprayer of FIG. 1.

FIG. 4 is a side elevational view of the sprayer of FIG. 1 showing functional components thereof in schematic form and a stored liquid (paint) being controllably sprayed out therefrom.

FIG. 5 is a side elevational view of the sprayer of FIG. 1 with the front and rear parts separated, the piston missing, and portions broken away for illustrative purposes.

FIG. 6 is a view similar to FIG. 5 but showing the front part being pushed into engagement with the rear part and the release/locking mechanism in the rear part being forced down by the engagement.

FIG. 7 is a view similar to FIG. 6 but showing the front and rear parts assembled together and the release/locking mechanism in a locked condition holding the front and rear parts together.

FIG. 8 is a view similar to FIG. 5 but with the sprayer having an alternative release/locking mechanism.

FIG. 9 is a view similar to FIG. 8 but showing the front part being pushed into engagement with the rear part and the button of the release/locking mechanism being (manually) pushed down.

FIG. 10 is a view similar to FIG. 9 but showing the front and rear parts assembled together, the button released and the release/locking mechanism in a locked condition holding the front and rear parts together.

FIG. 11 is an enlarged view in isolation of a cantilever clip that can be used in a sprayer first embodiment of this disclosure and wherein the first embodiment can be a modification of the sprayer of FIG. 1.

FIG. 12 is a front perspective view showing the clip of FIG. 11 operatively assembled in the rear (dry) part of the first embodiment.

FIG. 13 is a perspective view of the first embodiment with portions of the front (wet) part broken away for illustrative purposes and with the piston missing and showing the clip butting against a portion of the front part, preventing assembly of the front and rear parts.

FIG. 14 is a perspective view of the first embodiment showing a rear portion of the front part and a front portion of the rear part, with the front and rear parts partially assembled together and with the piston biasing a distal end of the clip to an upward position.

FIG. 15 is a perspective view of the first embodiment, assembled with the piston in place, a front portion of the (upwardly biased) clip inserted into the front part and portions of the front part broken away for illustrative purposes.

FIG. 16 is a front perspective view of a rear part of a sprayer second embodiment of this disclosure and which can be a modification of the sprayer of FIG. 1 and can use the release/locking mechanism of FIG. 5, for example.

FIG. 17 is an enlarged perspective view showing, in isolation, the safety lock of the second embodiment.

FIG. 18 is a lateral sectional view of the second embodiment with the piston missing and showing the safety lock in a first position.

FIG. 19 is view similar to that of FIG. 18 but with the piston in place and showing the safety lock in a second position.

FIG. 20 is a longitudinal sectional view of a portion of the second embodiment with the piston missing and the safety lock in the first position.

FIG. 21 is a view similar to that of FIG. 20 but with the piston in place and the safety lock in the second position.

FIG. 22 is an enlarged view of a pivotal blocking bracket, in isolation, and that can be used in a sprayer third embodiment of this disclosure and wherein the third embodiment can be a modification of the sprayer of FIG. 1.

FIG. 23 is a partially sectional side elevational view of the third embodiment and with the pivotal blocking bracket of FIG. 22 in a blocking position, the front and rear parts separated and the piston missing.

FIG. 24 is a view similar to that of FIG. 23 but with the piston in place and the pivotal blocking bracket in (moved to) a non-blocking position and biased against the piston.

FIG. 25 is a view similar to that of FIG. 24 but with the front and rear parts in an assembled condition.

FIG. 26 is a rear perspective view of the front part of the third embodiment and with the pivotal blocking bracket in the biased blocking position.

FIG. 27 is a view similar to that of FIG. 26 but with a forward portion of the piston in place and the pivotal blocking bracket in the pivoted non-blocking position.

FIG. 28 is a side elevational view of a sprayer fourth embodiment of this disclosure and which can be a modification of the sprayer of FIG. 1, and with the front and rear parts and the piston in a disassembled condition and showing a tether of this embodiment connecting the piston to the front part.

FIG. 29 is a partial front perspective view of the front part of the fourth embodiment and with a forward end of the piston in place in the front part.

### DETAILED DESCRIPTION

Corresponding reference numerals indicate corresponding parts throughout the several views of the drawings.

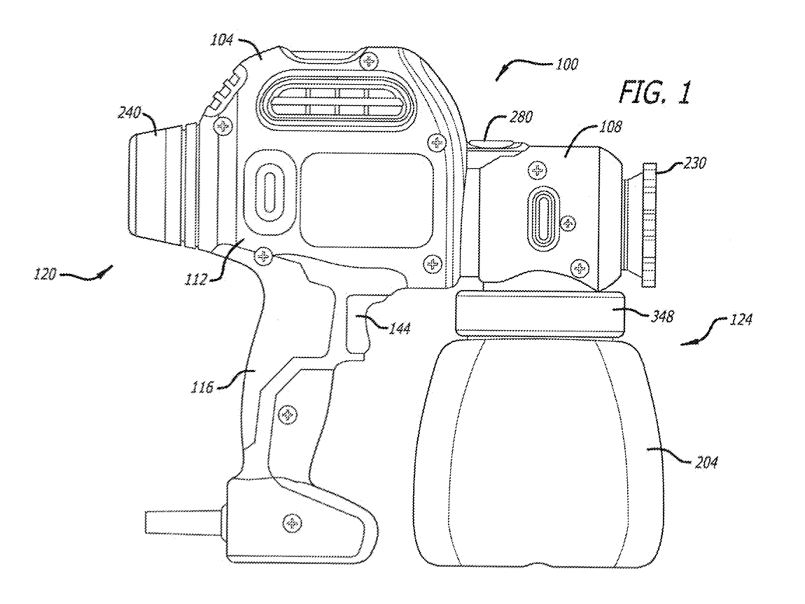

FIGS. 1-10 show various views and details of a paint sprayer shown generally at 100, such as the sprayer disclosed in the '041 PCT application. Sprayer 100 can be adapted to include various alternative teachings of the present disclosure, as explained in detail later in this disclosure. In other words, sprayer 100 can be modified to form different embodiments of this disclosure. However, as those skilled in the art will appreciate from this disclosure other sprayer constructions can also be modified to include teachings of this disclosure.

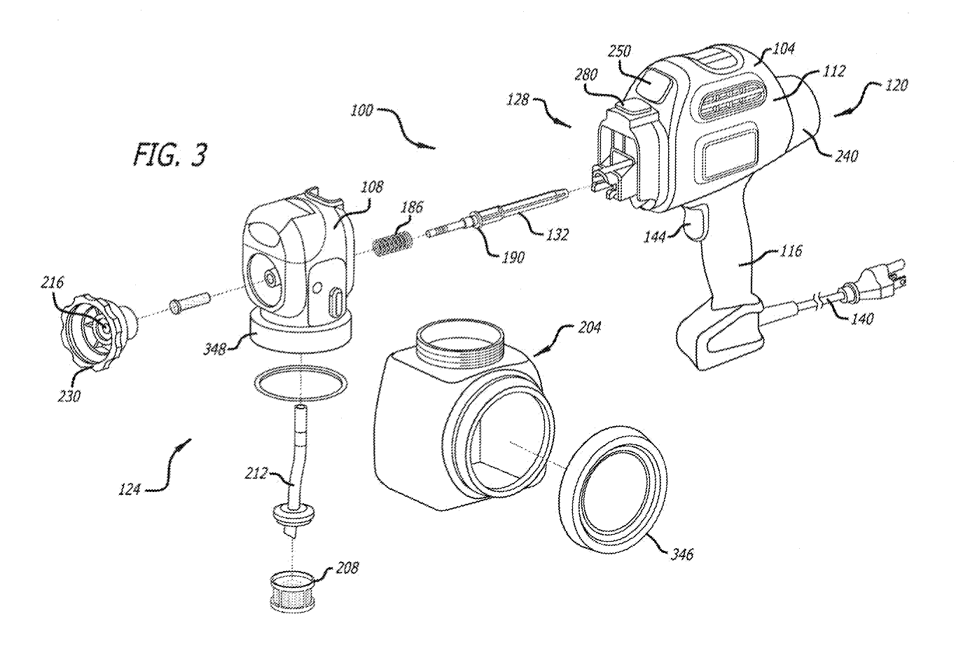

Spryer 100 can have a housing including a dry housing portion 104 and a wet housing portion 108. The dry housing portion 104 can define a housing body 112 and a handle 116, as shown for example in FIGS. 1 and 3. The wet housing portion 108 and the dry housing portion 104 can each be formed of clamshell housing halves.

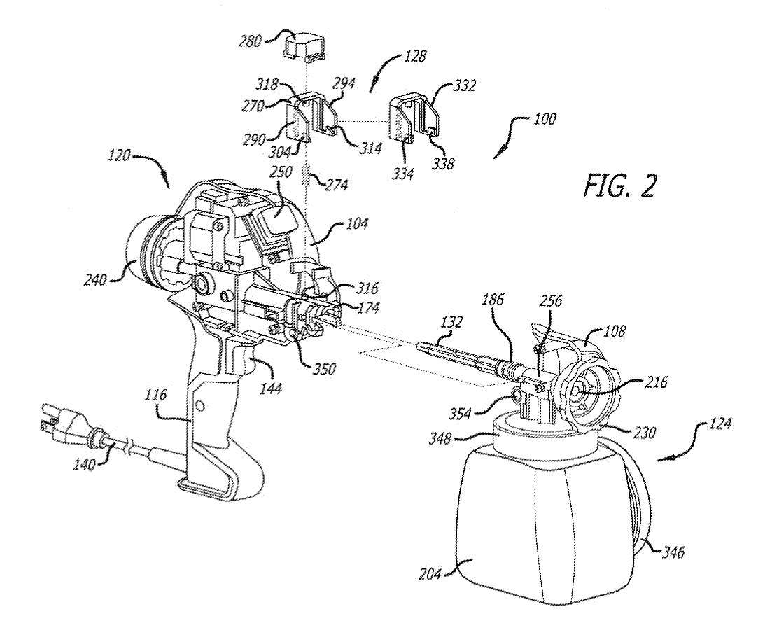

The sprayer 100 can be separated into a dry part, which is shown generally at 120 and which can include the dry housing portion 104, and a wet part, which is shown generally at 124 and which can include the wet housing portion 108. A catch (or release/locking) mechanism shown generally at 128 can controllably and releasably connect the two parts 120, 124 together. The components of the catch mechanism 128 are shown in exploded relation in FIG. 2, and the operation thereof is illustrated in the FIGS. 5-7 sequence of drawings and will be described in greater detail later.

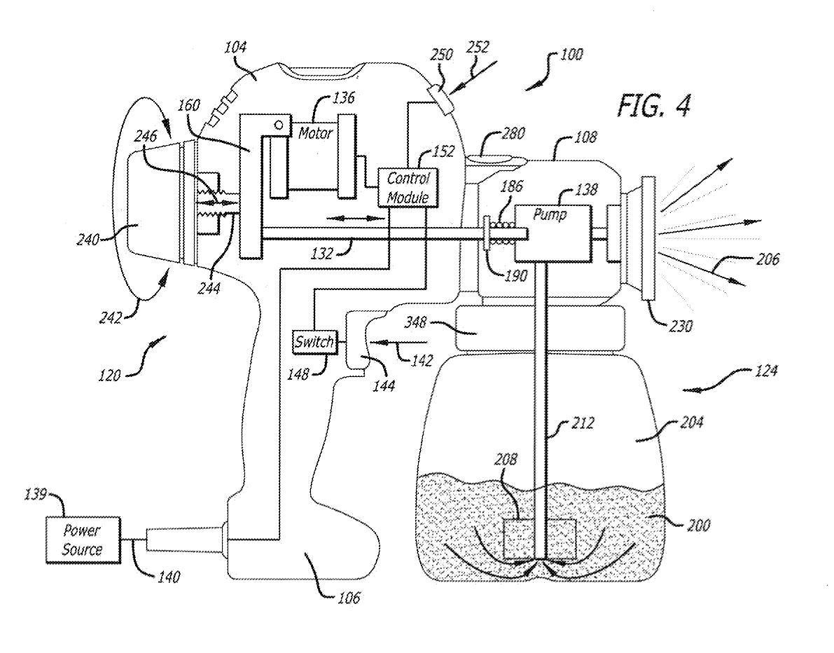

A piston 132 can mechanically connect the solenoid motor 136 in the dry part 120 with the pump 138 (FIG. 4) in the wet part 124. When the wet and dry parts 124, 120 are operatively assembled together the piston 132 can extend between them, as can be understood from FIG. 4, for example. When the wet and dry parts 124, 120 are disconnected from one another, the piston 132 can be disconnected from both of them, as can be understood from FIG. 3, for example. This allows the piston 132 and the wet part 124 to be cleaned without getting liquid in the dry part 120.

The basic operative components of the sprayer 100 are depicted in partial schematic form in FIG. 4. The motor 136 can be powered by a power source 139 (FIG. 4) via an electrical cord 140. Referring thereto, a user (not shown), holding the handle 116, can controllably squeeze (arrow 142) the trigger 144, which activates the switch 148 whose signal is sent to the control module 152. The control module 152 can control the operation of the solenoid motor 136. (An exemplary solenoid motor 136 can be a two amp or four amp motor, running at sixty hertz.) The solenoid motor 136 can include an armature that can reciprocate to drive an arm 160, which pivots about a pin.

An engagement portion on the arm 160 can be disposed at a rearward aperture in a channel member 174. The channel member 174 can extend toward the wet part 124 and can facilitate connection of the wet part 124 with the dry part 120. That is, the channel member 174 can be disposed in the dry housing portion 104 and adjacent to the solenoid motor 136. The channel member 174 can have a receiving aperture, which can be opposite to the rearward aperture and which can receive an end of the piston 132. A tip portion of the piston 132 can extend through the channel member 174 and connect with the engagement portion on the arm 160. A supporting boss can support and inhibit bending of the piston 132 during operation of the sprayer 100.

The piston 132 can extend from and connect to a chamber of the pump 140 in the wet part 124. An elastic member 186, such as a coil spring, can be disposed between the pump 140 and an annular surface 190 of the piston 132. The elastic member 186 can urge the end of the piston 132 away from the pump 140 and into an extended condition. Thereby, the piston 132 can reciprocate against the elastic member 186 and relative to the pump 140 between retracted and extended conditions. Thus, the solenoid motor 136 when energized can cause the piston 132 to reciprocate with the elastic member 186 biasing the piston to the left, as shown in FIG. 4, and the arm 160 moving the piston to the right.

Reciprocation of the piston 132 causes paint 200 (or other liquid media) to be pumped out of the reservoir body 204 through the filter 208 and via tube 212 and into the chamber of the pump 140. Then from the chamber the piston 132 can pump the paint 200 out a spray nozzle, as shown by 216. The pump 140 can thereby operate as a positive displacement pump, pumping paint 200 from the reservoir body 204 to the spray nozzle 216 and out an orifice portion. The orifice portion can atomize the paint 200, while the nozzle 216 imparts a spray pattern. Alternatively, the orifice portion and the spray nozzle can be formed as a single component.

A guard 230 can hold the spray nozzle 216, which is fluidly connected to the chamber opposite to the piston 132. Grasping and rotating the guard 230 can controllably change the orientation of the paint spray pattern, as desired for painting different surfaces.

Referring to FIGS. 3 and 4, for example, a spray adjuster can be provided to control the solenoid motor 136. The adjuster can include a knob 240 that can be rotated (arrow 242 in FIG. 4) by the user into one of a number of different positions. Each of the positions can be associated with the volume of paint 200 that is dispensed when the sprayer 100 is operated. As the knob 240 is rotated relative to the dry housing portion 104 a stopper 244 (FIG. 4) is thereby moved longitudinally (arrow 246) relative to the housing. The stopper 244 engages the arm 160, and the position of the end of the stopper defines the extent of pivoting motion of the arm. The less the pivoting motion, the smaller the amount of paint 200 sprayed. However, instead of mechanically controlling the amount of paint 200 emitted, the spray adjuster can be constructed to electronically control it.

The control module 152 is shown in FIG. 4 in block form in the dry housing portion 104. A switch 250 can be operatively connected to the control module 152 and can be manually accessible by the user on the dry housing portion 104. The user can operate (see arrow 252) the switch 250 to limit the output of the solenoid motor 136, for example, between a low mode and a high mode. Thereby the reciprocation rate of the solenoid motor 136 can be increased or decreased to provide relatively more or less pumping action, such as when the media being sprayed has a higher or lower viscosity.

Longitudinal protrusions 254 can be connected to the wet part's chamber channel 256 on opposite sides thereof. Rearward ends of the protrusions 254 can include respective posts 260. The protrusions 254 can be received in respective grooves 264 formed on opposite sides of the channel member 174 in the dry part 120. As the piston 132 is inserted into the channel member 174, the protrusions 254 are received and slide in the grooves 264 until the posts 260 abut respective stops. The piston 132 is thereby properly aligned and engaged with the arm 160.

The catch member or locking device 128 is shown in exploded view in FIG. 2 and in operation in FIGS. 5-7. The catch member 128 can include a clasp 270 disposed between an elastic member (such as a spring) 274 and a button 280. The button 280 can have a portion that extends out of and is accessible from outside of the dry housing portion 104. The button 280 can connect to a top portion of the clasp 270. And the clasp 270 can include opposing first and second legs 290, 294 spaced apart a sufficient distance so that the clasp can be disposed over the channel member 174 in the dry housing portion 104.

Referring to FIG. 2, the first leg 290 of the clasp 270 can include a first pocket 300 that is adjacent a first ramp 304, and similarly the second leg 294 can include a second pocket 310 that is adjacent a second ramp 314. The elastic member 274 can be further compressed when the catch member 128 is pushed from the extended condition to the retracted condition. The pockets 300, 310 on the catch member 128 in the extended condition can hold the posts 260 on the protrusions 254 that extend from the channel member 124. Thereby, the wet part 124 can be locked to the dry part 120 with the end of the piston 132 held in contact with the arm 160.

Referring to FIG. 2, for example, the button 280 can be pushed down by the user to drive the clasp 270 toward the channel member 174 and thereby into the retracted condition. The elastic member 284 (for example, a spring) can be compressed further, causing the legs 290, 294 of the clasp 270 to move downward and move the ramps 304, 314 of each of the legs out of obstruction with the posts 260 on each side of the channel member 174. The elastic member 278 can be held at opposite ends by respective retainer buttons 316, 318. Thereby, the elastic member 284 between the channel member 174 and the piston 132 can extend and increase the space between the chamber member and the piston. The wet part 124 is thereby pushed away from the dry part 120 so that the wet part can be disconnected and separated from the dry part. The engagement between the wet part 124 and the dry part 120 can thereby be broken and the piston 132 can be withdrawn from the channel member 174. The wet part 124, the reservoir body 204 and the piston 132 can then be cleaned and washed without exposing the dry part 120 to the cleaning process.

With the catch member 128 in the extended condition, the wet housing portion 108 can be connected to the dry housing portion 104; and the piston 132 can be inserted into the channel member 174 and the wet part 124 can be pushed against the dry part 120. When the posts 260 on the channel member 174 contact the ramps 304, 314 on the legs 290, 294 the posts can push the respective ramps down, thereby moving the catch member 128 from the extended condition to an at least partially retracted condition.

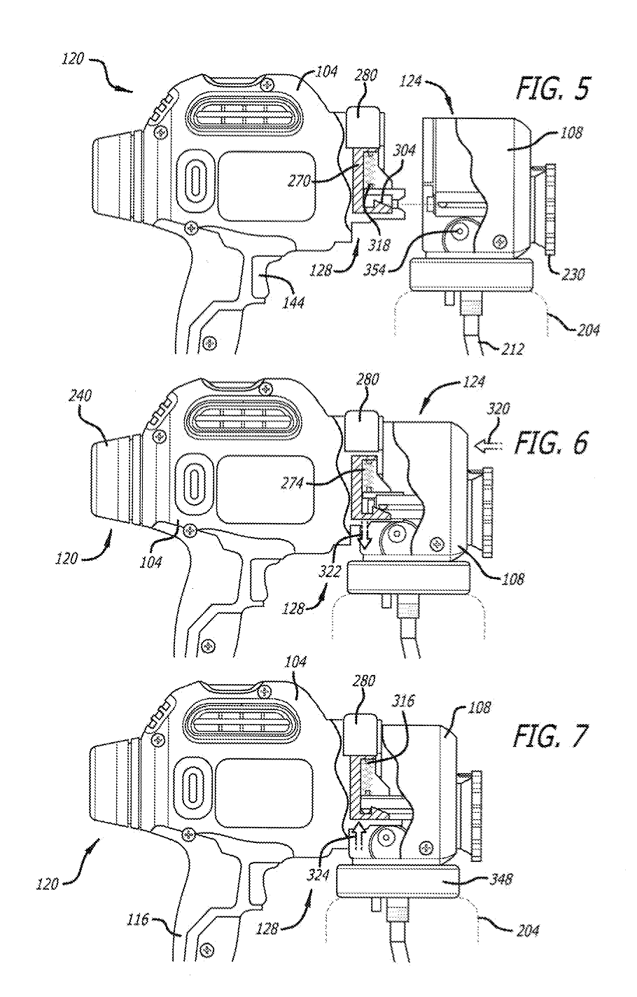

The wet housing portion 108 can be pushed into locking engagement with the dry housing portion 104 (as shown by arrow 320 in FIG. 6) and the posts 260 on the chamber member 128 can move over the ramps 304, 314, pushing the clasp 270 down (as shown by arrow 322) and into the pockets 300, 310 of the legs 290, 294. With the posts 260 seated into the respective pockets 300, 314, pushing the clasp 270 down (as shown by arrow 322) the catch member 128 can move from the retracted condition back to the extended condition, as shown by arrow 324. The piston 132 is thereby in an operable position.

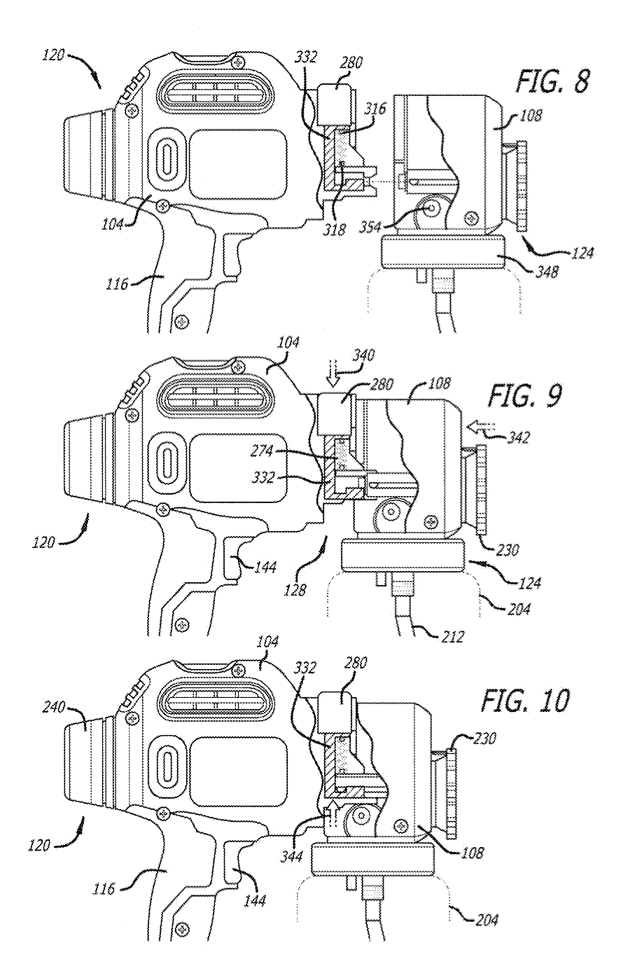

An alternative to the “catch” embodiment that is illustrated in FIGS. 5-7 and described above is illustrated in FIGS. 8-10 generally at 330, and by alternative clasp 332. Referring thereto the “ramps” 334, 338 are rectangularly shaped. The user thereby can move the catch member 330 to the retracted position, as shown by the vertical arrow 340 in FIG. 9, to permit connection of the wet housing portion 108 to the dry housing portion 104 by pushing the wet part 124 to the dry part 120 as shown by the arrow 342 and locking by releasing the button so that the ramp moves up as shown by the arrow 344 (FIG. 10).

With reference to FIG. 3, for example, to access the cavity defined by the reservoir body 204 to fill or empty the body with paint or the like 200, the sprayer 100 need only be tipped on its side and the cap 346 removed. The reservoir body 204 can be screwed into place in the wet part 124 via threads in the collar 348.

Additionally or alternatively to the locking device, connection bores 350, 354 can be provided, one or a pair on the dry housing portion 104 and one or a pair on the wet housing portion 108. And the bores 350, 354 can be pinned together by a pin (such as a threaded pin or a bolt with nut) to releasably lock the wet part 124 to the dry part 120.

Referring to FIG. 3, for example, the sprayer 100 can be disassembled by separating the wet part 124 from the dry part 120 and removing the piston 132 (and the elastic member 186). Thereby the wet part 124 and the piston 132 can be cleaned without getting any liquid on or in the dry part 120. However, the user may accidentally (or intentionally) omit the piston 132 when reassembling the sprayer, such as the sprayer 100 of FIG. 1. Not only will the sprayer 100 not then work, but also liquid may leak from the wet part 124 to the dry part 120 along the path provided for and occupied by the piston 132 when in place. This can cause problems with the electrical components, such as the solenoid motor 136 and/or the switch 148 in the dry part 120.

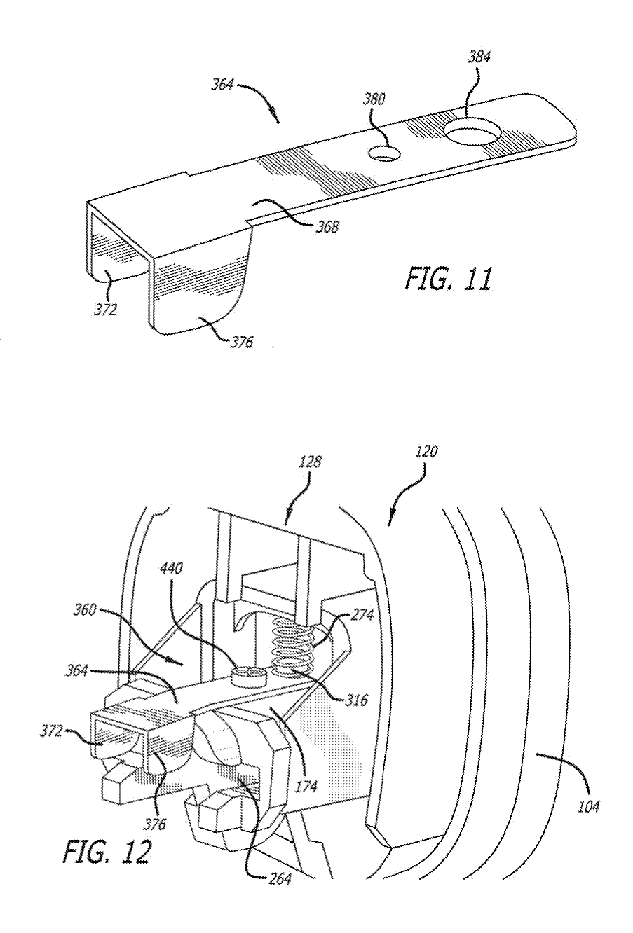

Disclosed herein are various ways for preventing the sprayer, such as sprayer 100 of FIG. 1, from being reassembled with the piston 132 missing. One way is to have a mechanism that can be connected to at least one of the wet and dry parts 124, 120. The mechanism can have a first configuration when the piston 132 is missing wherein the mechanism blocks the two parts from being assembled and a second configuration when the piston is in place wherein the mechanism does not block assembly. An embodiment of this way is illustrated in FIGS. 11-15 and described in detail later.

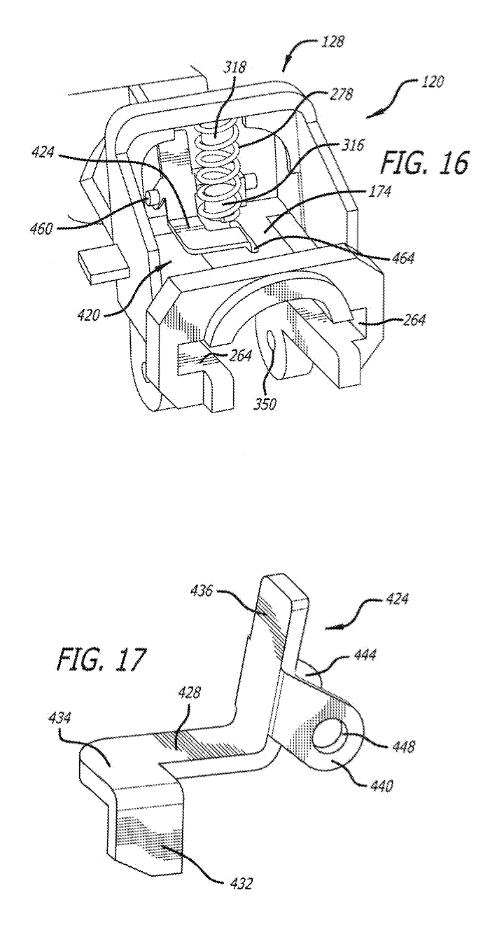

Another way is to have a mechanism that can be connected to at least one of the wet and dry parts 124, 120. The mechanism can have a first position when the piston 132 is not in place and that blocks actuation of a latch such as catch member 128 that allows the two parts to be connected. The mechanism can have a second position caused by the presence of the piston, which does not block actuation of the latch, such that the two parts can be connected. An embodiment of this way is illustrated in FIGS. 16-21 and described in detail later.

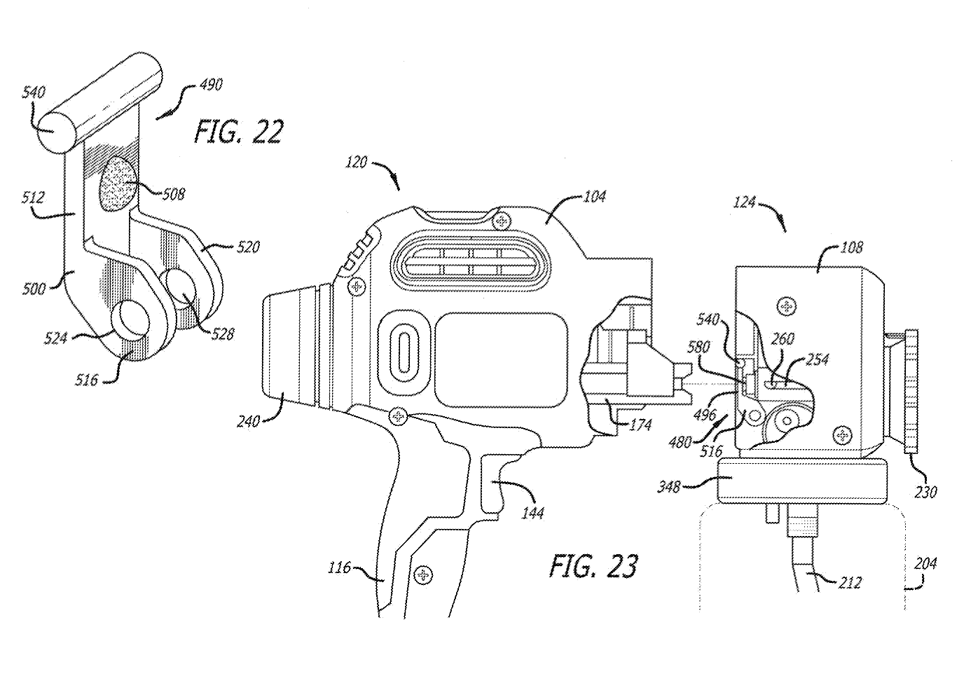

A further way is to have a mechanism that can be connected to at least one of the wet and dry parts 124, 120. The mechanism can have a first normal position when the piston 132 is not in place and that blocks the parts from being assembled. The mechanism can subsequently be moved to a second position to position an end of the piston 132 in one of the parts and when in the second position does not block the parts from being assembled. An embodiment of this way is illustrated in FIGS. 22-27 and described in detail later.

As mentioned above, an embodiment of the first way is illustrated in FIGS. 11-15 and generally at 360. This embodiment can include a cantilever clip, such as shown in isolation in FIG. 11 generally at 364. Clip 364 can be formed as a single-piece construction of spring steel or injection molded plastic, for example. The clip 364 can have a long elongate body portion 368, which can be generally one-and-a-half inches long and ⅜ inch wide, and can have at its distal end a pair of downwardly extending flanges or ears 372, 376. The ears 372, 376 can have identical or similar shapes and dimensions. First and second through-holes 380, 384 can be formed in the body portion 368.

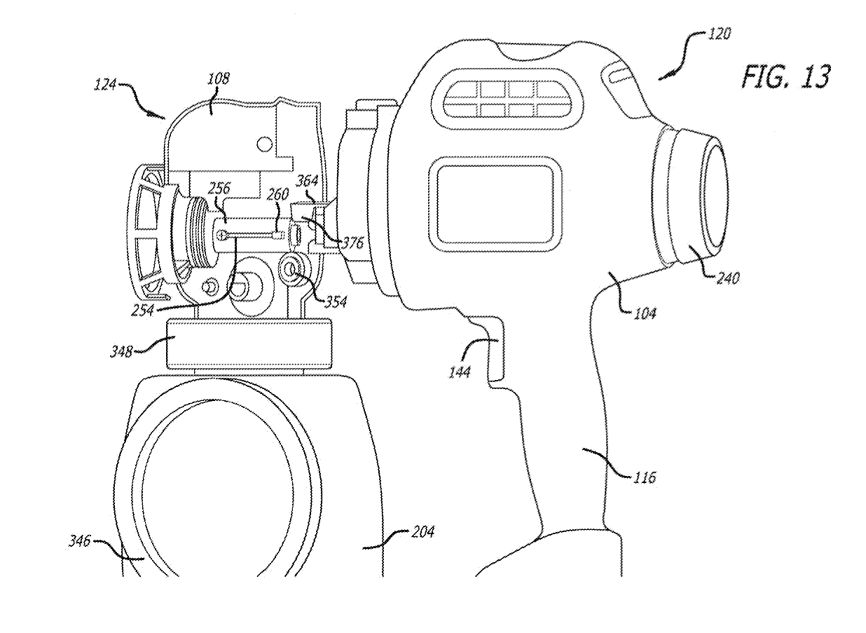

The cantilever clip 364 can be mounted as illustrated in FIG. 12, extending forwardly out from the dry part 120 and in a cantilevered manner with the wet and dry parts 124, 120 separated. The button 316 of the dry part 120 with spring 274 can extend up through the second hole 384. And a screw or other fastener 400 can extend down through the first hole 380 into the piston body or chamber channel member 174.

The clip 364 thereby extends cantilevered out from the dry part 120 and can be constructed with dimensions and materials such that it has both rigidity and flexibility. It can have rigidity sufficient such that when the piston 132 is not in place and a user attempts to assemble the wet part 124 to the dry part 120, the distal end of the clip 364, or more particularly the flanges 372, 376, impact the metal casing, piston body or chamber channel 256 in the wet part and thereby block/prevent assembly of the parts. This can be understood from FIG. 13.

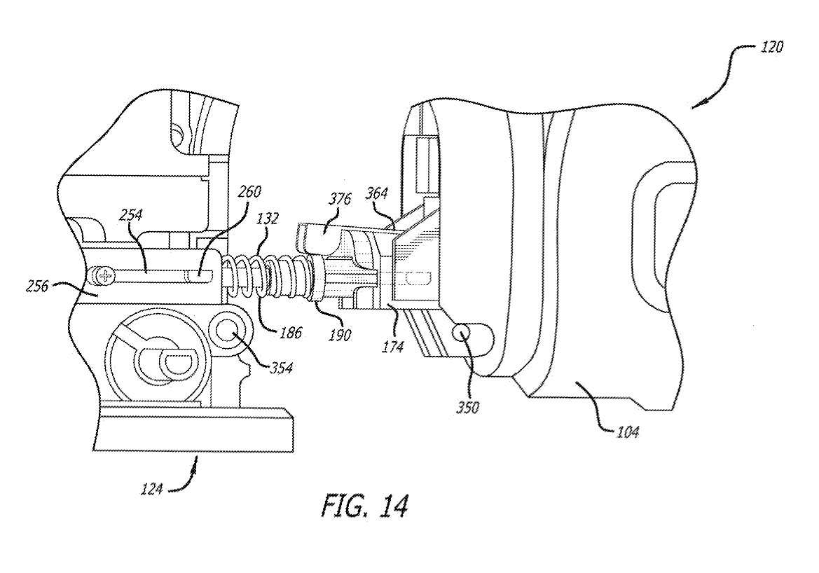

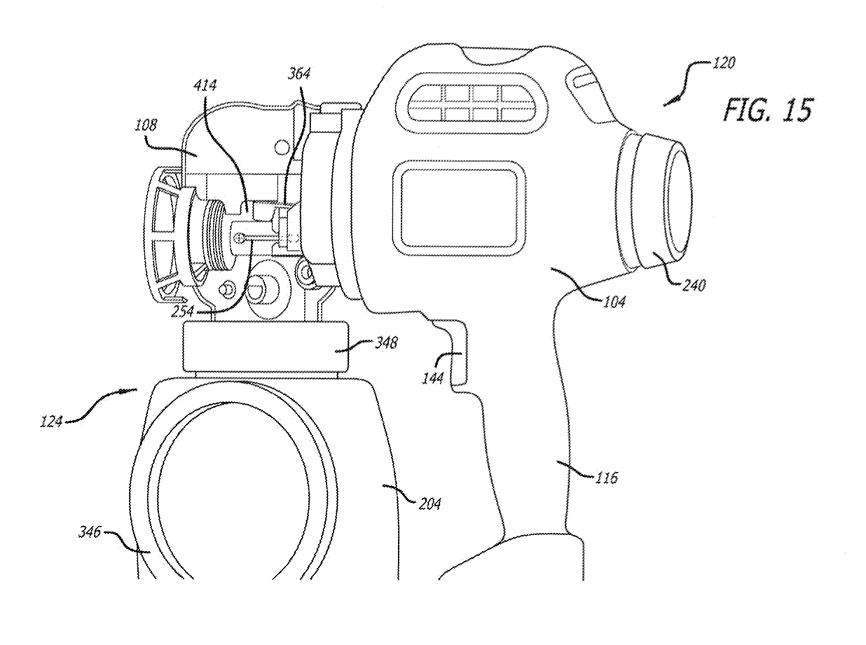

On the other hand, the cantilevered clip 364 can have flexibility sufficient such that when the piston 132 is inserted in place into the channel member in the dry part 120, the top part of the piston 132 engages the ears or flanges 372, 376 of the clip 364 and biases/flexes the end portion of the clip upwards, as can be understood from FIG. 14. Thereby, the end portion of the clip 364 can be pushed up about ⅛ to 3/16 inch, compared with the unbiased configuration or position of FIGS. 12 and 13. In this second configuration or position the end face does not engage the metal casing or chamber channel 256 but rather it (or more specifically, the ears or flanges 372, 376 thereof) can ride up on top of the piston (FIG. 14) and fit into the opening 414 above and on both sides thereof, and slide into the wet part 124. This is depicted in FIG. 15.

The end portion of the clip 364 can have alternative configurations to fit into different sizes and shapes of openings 414 in the wet part 124 and to engage the piston 132 or elastic member 186 (FIG. 14). Alternatively, the mechanism can be configured for other relative first and second positions. Accordingly, the wet (front) part 124 and dry (rear) part 120 can be assembled and latched together and the piston 132 thereby is in an operable position with respect to the pump 140 and the arm 160.

As mentioned above, an embodiment of the second way is illustrated in FIGS. 16-21. A mechanism of this embodiment shown generally at 420 can have two positions, namely, a first position when the end of the piston 132 is not in place in the dry part 120 (as shown in FIGS. 16, 18 and 20) and a second position when the end of the piston is in place (as shown in FIGS. 19 and 21). Briefly, when in the first position the mechanism 420 prevents the latch or catch 128 from allowing the wet and dry parts 124, 120 to be assembled, and when in the second position the mechanism does not prevent the latch from allowing the wet and dry parts to be assembled together.

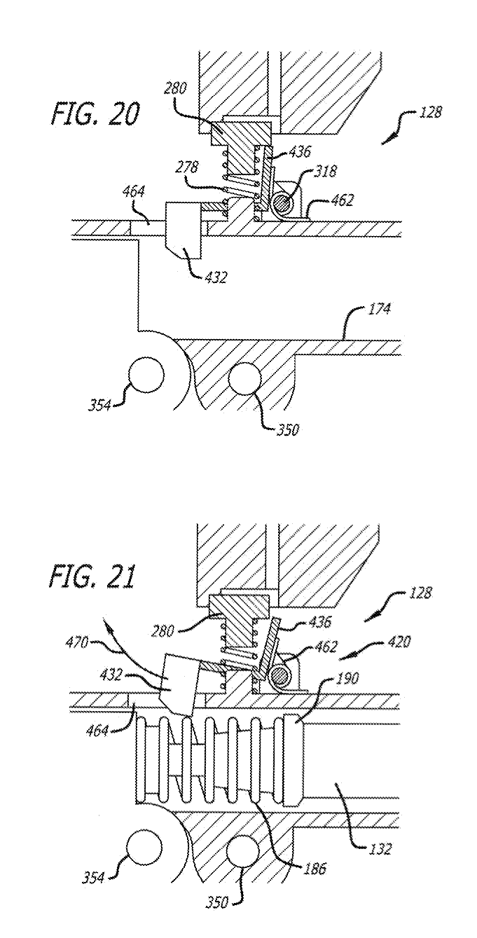

More specifically, the mechanism 420 can include a pivotal bracket as shown in isolation in FIG. 17 generally at 424. The pivotal bracket 424 can have a single (or multiple) piece construction made from injection molded plastic or formed and bent metal (steel). An exemplary pivotal bracket 424 can include a base portion 428 (generally ¼ inch long), a side downward portion 432 (generally ½ inch long), a short sideward portion 434 and an upright (inclined) portion 436 (generally ¾ inch long). A pair of ears 440, 444 extends rearwardly on opposite sides of the upright portion 436. Each of the ears 440, 444 can have a respective through-hole 448, 452 for receiving therein a torque rod 460, as can be seen in FIGS. 20 and 21, for example, including a torque spring 462.

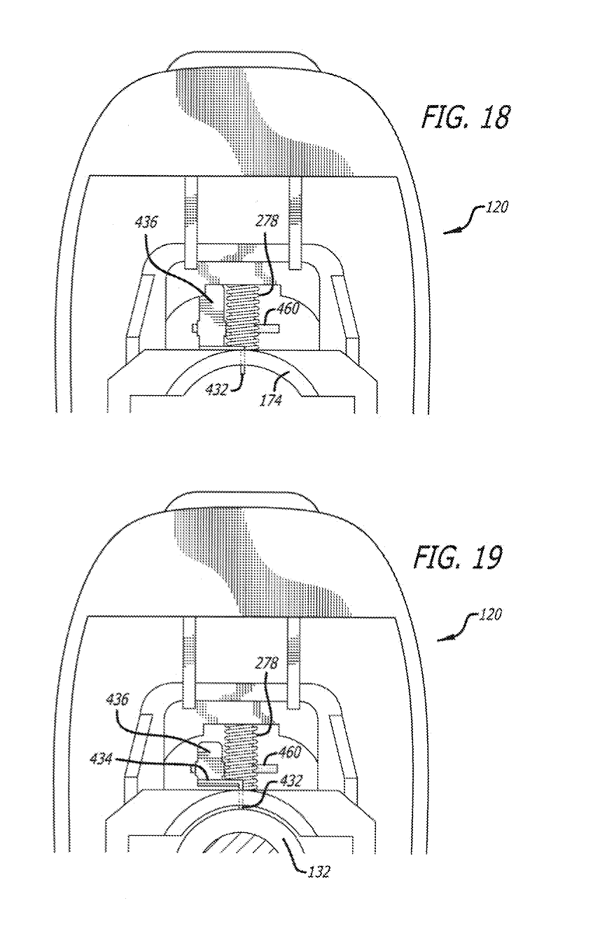

The torque rod 460 biases the mechanism 420 to the first position with the downward portion 432 in a slot 464 in the motor bracket casing or chamber channel member 256. The sideward portion 434 positions the upright portion 436 to a side of the spring 256 and parallel to and spaced from the slot 464 as can be understood from FIG. 16. The spring 284 can have its opposite ends held in spring retention buttons or bosses 316, 318, as shown in FIG. 16. When in the first position, as shown in FIGS. 18 and 20, the top edge of the upright portion 436 engages a bottom surface of the button 280, thereby preventing the button from being moved downwardly and thus preventing the wet and dry parts 124, 120 from being connected together.

When the piston 132 is inserted into the channel member 174 at the front end of the dry part 120, the bracket 424 is moved to a second position where it does not block the downward movement of the button 280. This position is shown in FIGS. 19 and 21. More particularly, the piston 132 (by itself or including the elastic member 186) engages and pushes against the downward portion 432, causing the pivotal bracket 424 to pivot about the torque rod 460 (as represented by arrow 470 in FIG. 21) and against the tension of the torque rod, or to the right as drawn in FIG. 21. The top edge of the upright portion 436 is no longer disposed under the button 280 and thereby does not block the downward movement of the button.

Different shapes and constructions of the mechanism 420 and particularly the bracket 424 as would be apparent to those skilled in the art are within the scope of this disclosure. For example, the mechanism 420 can be positioned in the wet part 124 instead of the dry part 120. Another way of describing mechanism 420 is that it is part of the locking device 128 and/or together therewith forms a locking assembly of the sprayer.

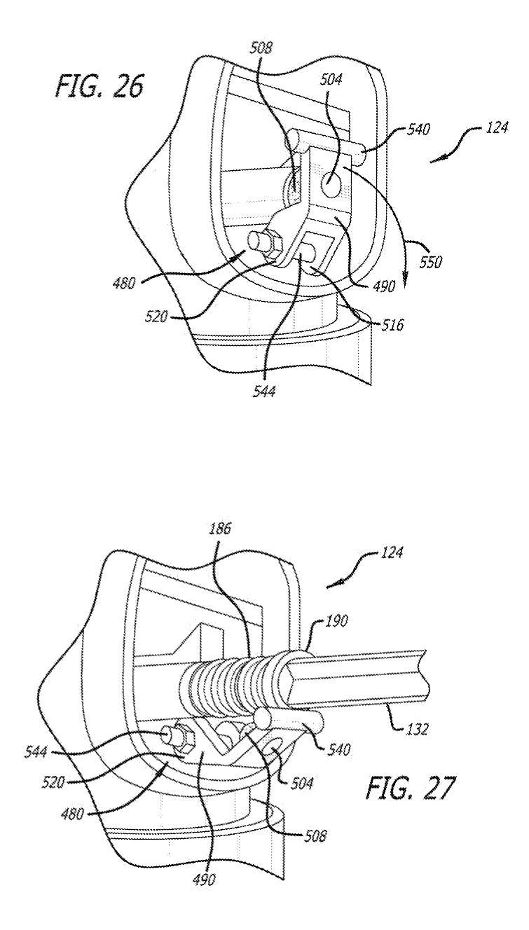

As mentioned above, an embodiment of the third way is illustrated in FIGS. 22-27. While the mechanism 480 is illustrated as being attached to the wet part 124, those skilled in the art would understand that it is also within the scope of the present disclosure to attach it to the dry part 120. The mechanism 480 can include a pivotal bracket as depicted in isolation in FIG. 22 at 490. The pivotal bracket 490 can include a first member 500 having an opening 504 (FIGS. 26 and 27) in which a second member 508 is held. The second member 508 can be a rounded (for example, a spherical cap) plug extending rearwardly from the back surface of the first member 500 and affixed in the opening 504 by a pressure fit, adhesive and/or the like. The second member 508, for example, can be a rubber plug having a ⅜-inch diameter.

The first member 500 can be a one-piece or multiple-piece construction. For example, it can be formed of injection molded plastic or aluminum casting. The first member 500 can have a body portion 512 in which the opening 504 is positioned, and a pair of ears 516, 520 extending downwardly and rearwardly (that is, at an angle) from bottom side edges of the body portion. The ears 516, 520 can be parallel to one another and spaced apart. Each ear 516, 520 can have a respective through-hole 524, 528 (FIG. 22) aligned with one another and about an axis parallel to a lateral axis of the body portion 512.

The first member 500 can further include a bar 540 mounted at the top edge of the body portion 512 and having a length of generally an inch. The bar 540 can be an elongate round cylinder, having a diameter greater than the thickness of the body portion 512 and extending out from the front and back faces of the body portion, and having a length greater than the width of the body portion and extending out from both left and right side edges of the body portion. The mechanism 480 can further include a torqued bar 544 (FIGS. 26 and 27) having a torsion spring, passing through the aligned holes 524, 528 and pivotally mounting the pivotal bracket 490 to the wet part 124, at a back face thereof and as part thereof.

The torqued bar 544 can position and hold the pivotal bracket 490 in a normal “upright” position with the body portion 512 disposed generally vertically as can be seen in FIGS. 23 and 26. When in this normal upright position, the plug 508 can be fitted in the end of the opening of the chamber channel 256 in the wet part 124. The plug 508 thereby can prevent leakage out of the wet part 124 and also prevent damage to the end of the channel from impact by the pivot bracket 490. When a user attempts to assemble disconnected wet and dry parts 124, 120 with the piston 132 missing (that is, the piston is not in position), the bar 540 abuts the motor housing casting or channel member 174 and prevents assembly.

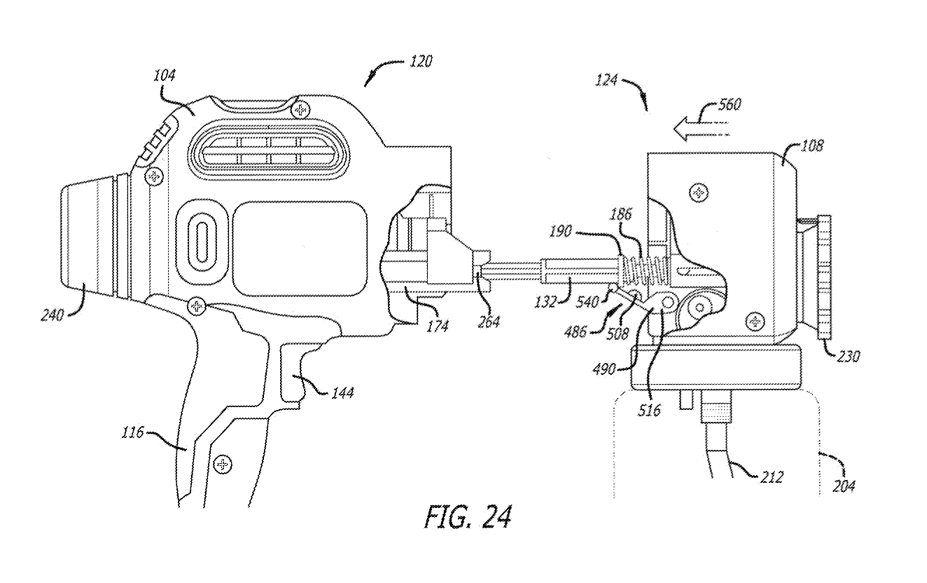

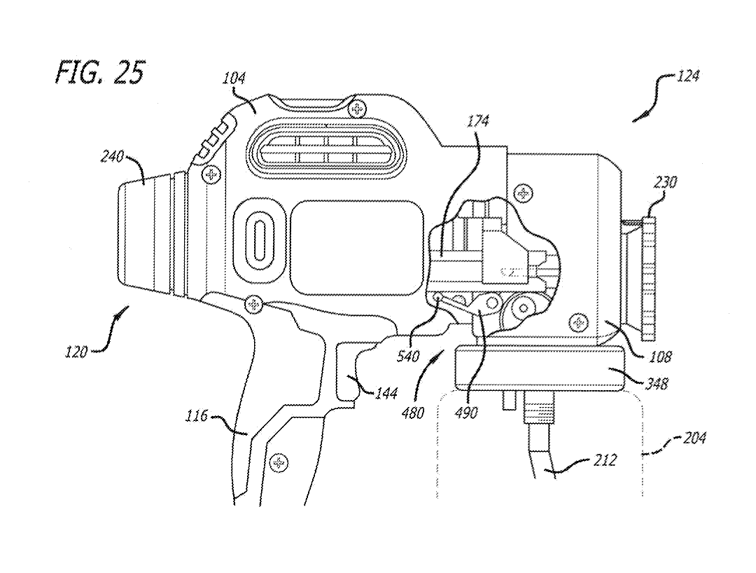

On the other hand, the mechanism 480 does not block assembly of the wet and dry parts 124, 120 when the piston 132 is in place (in the wet part). The pivotal bracket 490 can be (manually) moved to a second downward position, against the bias of the torque rod 544, and as shown by arrow 550 in FIG. 26. And the “spring” end of the piston 132 can be inserted into the wet part 124 and the pivotal bracket 490 released to be biased, by the torque rod 544, against a (bottom) surface of the piston 132, as illustrated in FIG. 27. FIG. 24 shows the opposite end of the piston 132 in the dry part 120. The wet and dry parts 124, 120 can then be pushed together as shown by the arrow 560 to assemble them. The bar 540 rides along the bottom of the casting into an inserted position in the dry part 120, as shown in FIG. 25. The connection bore 350 as depicted in FIG. 2, can be removed/omitted for this sprayer embodiment so as to not block or interfere with the insertion of the pivotal bracket 490 into the dry part 120. The round bar 540 provides a sliding surface for the pivotal bracket 490, and it can have a length adapted to center and guide the pivotal bracket into and along the opening.

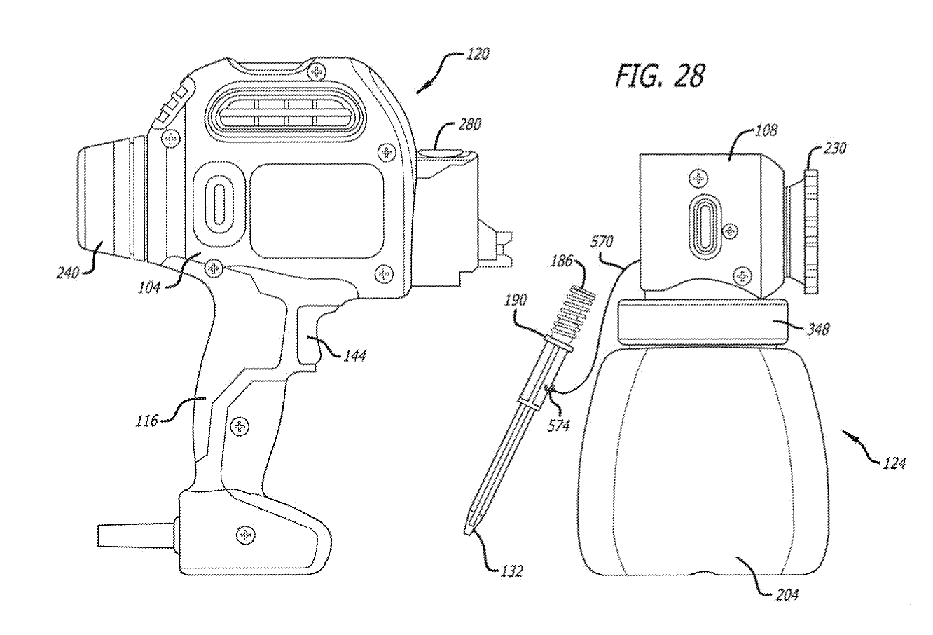

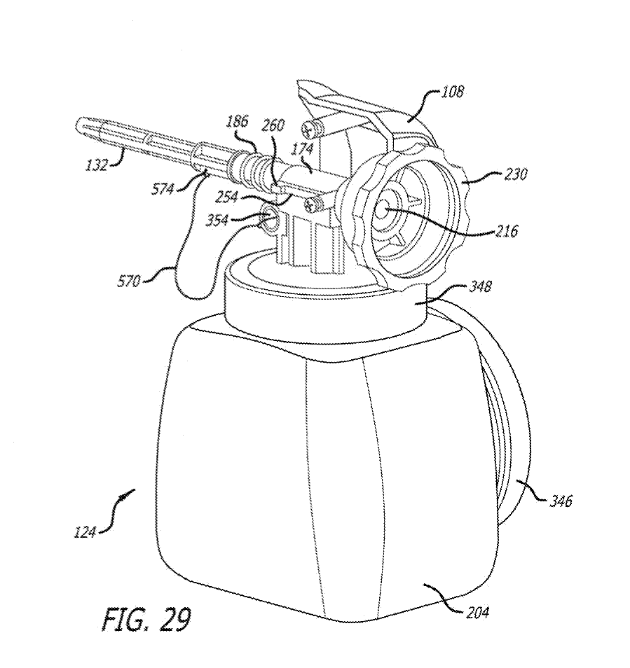

Another way of reducing the likelihood that the sprayer will be assembled without the piston 132 in place is to tie the piston to the wet part 124 (or the dry part 120). This can be done with a tie or tether, an example of which is shown in FIGS. 28 and 29 at 570. The tie or tether 570 can be generally two (or 1½ to three) inches long and can be made of string, wire or coiled spring. It can have one end attached to the connection bore 354 of the wet part 124 and the opposite end attached to a ring 574, which is attached to a center portion of the piston 132. This tie or tether 570 not only prevents the piston 132 from being lost but also reminds the user to position it in place between the wet and dry parts 124, 120 when assembling them together. The tie or tether 570 can be tucked into a space of the sprayer when the parts are assembled.

Each of the above-mentioned ways can be used in the sprayer 100 of FIG. 1, adapted and modified for example as illustrated in the drawing figures and the present description. Each also can be used in sprayers (or other tools) of other designs and operations, even when the omitted component is other than a piston. That is, the concepts of this disclosure, while illustrated as being used in a modified '041 application spray pump, can be adapted and used in/with various existing or to be developed pump constructions, as well as existing spray pumps.

While the drawings show assembly of the sprayer being prevented with the piston 132 and the elastic member 186 missing, the present disclosure includes sprayers constructed such that assembly thereof is prevented when just the elastic member 186, piston 132 or other part that may help contribute to a sealing off of the dry part 120 from the wet part 124 is missing.

FIG. 4 in particular shows the different operative components and their arrangement, which can be used in sprayers pursuant to the present disclosure. It is also contemplated that the embodiments of the present disclosure can be used with paint sprayers other than solenoid-type paint sprayers. For example, they can be used with rotary, HVLP (high volume, low pressure) or other types of paint sprayers.

The foregoing description of exemplary aspects of the present teachings has been provided for purposes of illustration and description. Individual elements or features of a particular aspect of the present teachings are generally not limited to that particular aspect, but, where applicable, are interchangeable and can be used in other aspects, even if not specifically shown or described. The same may also be varied in many ways. Such variations are not to be regarded as a departure from the present teachings, and all such modifications are intended to be included within the scope of the present teachings. The present disclosure further includes sub-assemblies, as well as methods of using and/or making the sprayer and/or components thereof.

The terminology used herein is for the purpose of describing particular example embodiments only and is not intended to be limiting. As used herein, the singular forms “a,” “an” and “the” may be intended to include the plural forms as well, unless the context clearly indicates otherwise. The terms “comprises,” “comprising,” “including” and “having” are inclusive and therefore specify the presence of stated features, integers, steps, operations, elements and/or components, but do not preclude the presence or addition of one or more other features, integers, steps, operations, elements, components and/or groups thereof. The method steps, processes and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (such as “between” versus “directly between,” and “adjacent” versus “directly adjacent”). As used herein, the term “and/or” includes any and all combinations of one or more of the associated listed items.

Although the terms first, second, third and so forth may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second” and other numerical terms when used herein do not imply a sequence or order unless clearly indicated by the context. Thus, a first element, component, region, layer or section discussed below could be termed a second element, component, region, layer or section without departing from the aspects of the present teachings.

Spatially relative terms, such as “inner,” “outer,” “beneath,” “below,” “lower,” “above” and “upper,” may be used herein for ease of description to describe one element's or feature's relationship to another, but the application is intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated ninety degrees or at other orientations) and the spatially relative descriptors used herein interpreted accordingly.

1. A sprayer comprising:
a sprayer rear part;
a sprayer front part positionable in an operative connected position relative to the rear part and in an alternative disconnected position relative to the rear part;
a piston positionable in an operative position extending between the rear part and the front part when the front part is in the connected position and alternatively positionable in a disconnected position disconnected from both of the rear and front parts when the front part is in the disconnected position; and
a blocking mechanism connected to the rear and/or front parts and configured to prevent the front part from being positioned in the connected position when the piston is in the disconnected position.

2. The sprayer of claim 1 wherein the blocking mechanism is in a non-blocking position when the piston is in a connecting position with one end portion of the piston in the rear part and an opposite end portion in the front part so as to not prevent the front part from being positioned in the connected position.

3. The sprayer of claim 2 wherein the piston when an end portion thereof is operatively in an opening in the rear or front parts causes the blocking mechanism to be biased to and/or maintained in the non-blocking position.

4. The sprayer of claim 1 wherein the blocking mechanism includes a pivotal bracket.

5. (canceled)

6. (canceled)

7. (canceled)

8. The sprayer of claim 1 wherein the blocking mechanism includes a cantilevered clip.

9. (canceled)

10. (canceled)

11. The sprayer of claim 1 wherein the blocking mechanism includes a pivotal locking assembly.

12. (canceled)

13. (canceled)

14. The sprayer of claim 1 further comprising a connecting mechanism that is movable between a preventing position that prevents the front part from being connected to the rear part and an actuation position that allows the front part to be connected to the rear part, and wherein the blocking mechanism prevents the connecting mechanism from being moved from the preventing position to the actuation position when an end of the piston is not in place relative to the front part or the rear part.

15. A sprayer comprising:
a sprayer dry part;
a sprayer wet part; and
a sprayer component whose absence from a position between the dry and wet parts prevents the dry and wet parts from being operatively assembled together and whose presence between the dry and wet parts when operatively assembled together at least in part prevents leakage from the wet part to the dry part.

16. (canceled)

17. The sprayer of claim 15 further comprising a mechanism connected to the dry and/or wet parts and having a first position or configuration when the component is not in place relative to the dry and/or wet parts and a second position or configuration when the component is in place relative to the dry and/or wet parts, and wherein the mechanism when in the first position or configuration prevents the dry and wet parts from being operatively assembled together.

18. The sprayer of claim 17 wherein the component when in place causes the mechanism to pivot and/or bend to the second position or configuration.

19. (canceled)

20. The sprayer of claim 17 further comprising a connecting latch and wherein the mechanism when in the first position or configuration blocks operation of the connecting latch.

21. The sprayer of claim 15 further comprising a catch mechanism that is configured to connect the wet and dry parts together, and the catch mechanism is in a blocking position that prevents the wet and dry parts from being connected together when the component is not in place.

22. A sprayer comprising:
a sprayer wet part;
a sprayer dry part;
a sprayer component that when assembled relative to at least one of the wet and dry parts and when the parts are operatively assembled together, at least in part prevents or helps prevent leakage from the wet part to the dry part; and
a mechanism that is connected to one of the wet or dry parts and is configured to prevent the wet and dry parts from being assembled together when the component is not in place relative to the wet part and/or the dry part.

23. (canceled)

24. The sprayer of claim 22 wherein the mechanism includes a flexible clip.

25. The sprayer of claim 22 wherein the mechanism includes a pivotal blocking bracket or a pivotal safety lock.

26. The sprayer of claim 22 wherein the mechanism, when the component is not in place, is in a first position or configuration that prevents the wet and dry parts from being assembled together and wherein the mechanism, when the component is in place, is in a second position or configuration that does not prevent the parts from being assembled together.

27. (canceled)

28. (canceled)

29. (canceled)

30. (canceled)

31. (canceled)

32. The sprayer of claim 26 further comprising a lock that prevents the parts from being assembled together unless the lock is in an unlocked condition, and the mechanism is configured to block the lock from being in the unlocked condition when the mechanism is in the first position or configuration and is configured to not block the lock from being in the unlocked condition when the mechanism is in the second position or configuration.

33. (canceled)

34. (canceled)

35. A sprayer comprising:
a sprayer wet part;
a sprayer dry part;
a sprayer component that at least in part prevents leakage from the wet part to the dry part when the wet and dry parts are operatively connected together; and
means for preventing the wet and dry parts from being operatively connected together without the component being in place relative to at least one of the wet and dry parts.

36. The sprayer of claim 35 wherein the preventing means includes a cantilevered clip, a pivotal blocking bracket or a pivotal safety lock.

37. The sprayer of claim 35 wherein the component is in place when an end portion thereof is operatively in an opening or recess in the at least one of the wet and dry parts.

38. (canceled)

39. (canceled)
